(19) United States
(12) Patent Application Publication
(10) Pub. No.: US 2018/0061258 A1
(43) Pub. Date: Mar. 1, 2018

(54) DATA DRIVEN FEATURE DISCOVERY

(71) Applicant: MICROSOFT TECHNOLOGY LICENSING, LLC, Redmond, WA (US)

(72) Inventors: Vlad Riscutia, Redmond, WA (US); Alexis Odell, Redmond, WA (US); Michael Navarro, Kirkland, WA (US); Darron Stepanich, Redmond, WA (US)

(73) Assignee: MICROSOFT TECHNOLOGY LICENSING, LLC, Redmond, WA (US)

(21) Appl. No.: 15/248,104

(22) Filed: Aug. 26, 2016

(51) Int. Cl. G09B 5/12; G06F 17/30; G06N 5/02

(52) U.S. Cl. CPC G09B 5/12; G06N 5/022; G06F 17/30867

(57) ABSTRACT

An educational content application or a service may determine which features to present to a user based on the user's past usage patterns, current system/application configuration(s), preferences, and comparable attributes. The selection may also be made based on other users' similar data. Furthermore, a forum or channel to present the feature and a timing of presentation may also be selected based on similar actors. The features may include a previously unused feature, an underutilized feature, and/or a new, feature, among others.

### BACKGROUND

Cloud based service architectures are increasingly replacing conventional locally installed application based solutions. A wide range of services from data storage, collaboration, productivity, to specialized services are more and more provided by subscription based cloud service providers. At the same time—not necessarily related, a number of features and capabilities of many applications are increasing. Competition among application providers is not only based on cost, but also a number and quality of features provided by each application. A result of this development is frequent and numerous release of application/service features.

One result of increased release of new features is user apathy. As users are boarded with updates, upgrades, and new features for a number of applications each day/week/month, they tend to ignore the new features. Lack of easy to use training presentation methods may also lead to underutilization of application features.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing data driven feature discovery and presentation. According to some examples, information associated with a feature that is associated with one or more applications within a hosted service may be received. User information for a target user associated with the one or more applications and user information for a group of other users associated with the one or more applications may be retrieved. Next, a determination may be made on whether to present the feature to the target user, a timing to present the feature to the target user, and a forum to present the feature to the target user based on the retrieved user information for the target user and the user information for the group of other users. The educational content associated with the feature may be provided to be displayed to the target user at the timing and through the forum based on the determination.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example system to provide new feature discovery and presentation in conjunction with a productivity service, according to embodiments;

FIG. 2 is a display diagram illustrating use of a predictive engine in providing new feature discovery and presentation, according to embodiments;

FIG. 3 is a display diagram illustrating example components in providing new feature discovery and presentation, according to embodiments;

FIG. 4 is a display diagram illustrating example user interface configurations in providing new feature discovery and presentation, according to embodiments;

FIG. 5 is a simplified networked environment, where a system according to embodiments may be implemented;

FIG. 6 is a block diagram of an example computing device, which may be used to provide new feature discovery and presentation, according to embodiments; and

FIG. 7 is a logic flow diagram illustrating a process for providing in providing new feature discovery and presentation, according to embodiments.

### DETAILED DESCRIPTION

As briefly described above, an educational content application or a service may determine which features to present to a user based on the user's past usage patterns, current system/application configuration(s), preferences, and comparable attributes. The selection may also be made based on other users' similar data. Furthermore, a forum or channel to present the feature and a timing of presentation may also be selected based on similar factors. The features may include a previously unused feature, an underutilized feature, and/or a new feature, among others.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide data driven feature discovery and presentation. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

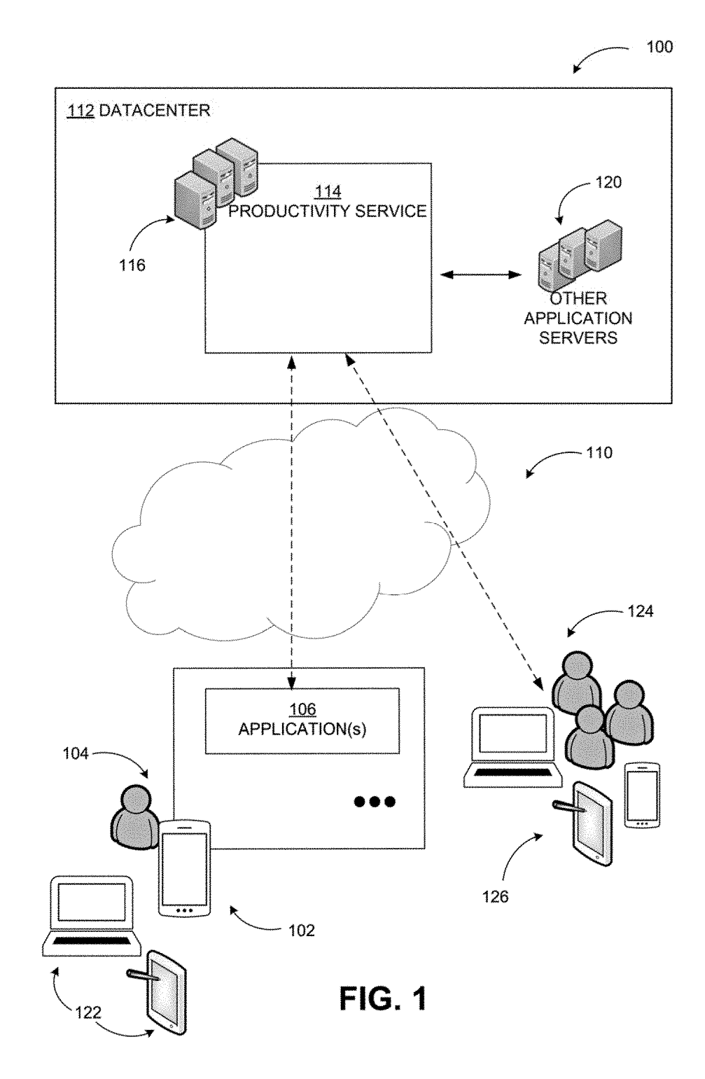

FIG. 1 is a conceptual diagram illustrating an example system to provide new feature discovery and presentation in conjunction with a productivity service, according to embodiments.

As illustrated in diagram 100, an example system may include a datacenter 112 hosting a cloud-based productivity service 114 configured to provide productivity applications such as word processing, spreadsheet, presentation, communication, collaboration, and comparable ones that may be accessed across multiple devices and users. The datacenter 112 may include one or more processing servers 116 configured to execute the productivity service 114, among other components. In some embodiments, at least one of the processing servers 116 may be operable to execute a predictive engine of the productivity service 114, where the predictive engine may detect applicable features for users associated with one or more of the applications provided under the productivity service umbrella and present those features to the users through a variety of channels along with training opportunities. The datacenter 112 may also include one or more other application servers 120 configured to provide complementary services and work in conjunction with the productivity service 114 such as data storage services. As described herein, the productivity service 114 and/or the predictive engine may be implemented as software, hardware, or combinations thereof.

In some embodiments, the productivity service 114 may be configured to intemperate with various applications. For example, as illustrated in the diagram 100, a user 104 may execute a thin (e.g., a web browser) or a thick (e.g., a locally installed client application) version of an application 106 through the device 102 with which the productivity service 114 may be configured to integrate and interoperate with over one or more networks, such as network 110. The application 106 may be an application hosted by the productivity service, such as a word processing or spreadsheet client, for example. The device 102 may include a desktop computer, a laptop computer, a tablet computer, a vehicle mount computer, a smart phone, or a wearable computing device, among other similar devices. A communication interface may facilitate communication between the productivity service 114 and the application 106 over the network 110.

Some of the actions and or processes described wherein have been illustrated from the perspective of a server (for example, the processing servers 116 configured to execute the productivity service), however the same actions may be performed similarly by a client (for example, the application 106), among other entities. Additionally, some of the actions and/or processes described herein have been illustrated from the perspective of the client, however the same actions may be performed similarly by the server.

Conventionally, some cloud-based services and/or providers may offer a periodic or on-demand upgrades, updates, and other features releases, which enables users to activate and use a wide variety of features for different applications. However, keeping up with a large number of new features, determining which ones are worth a user's time and effort to learn and implement, and actually training on the new feature are challenges that may detriment user experience and result in fewer users taking advantage of the capabilities of new features. By providing data driven discovery and presentation of features, user interaction efficiency may be increased along with a reduction in network bandwidth usage and processing resource usage (memory, hard drive, processor) by avoiding repeat presentations that are not viewed by a user, activation of a higher number of new features increasing efficiency of services/applications.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users storing and/or sharing content both locally at client devices and remotely at cloud-based services.

Example embodiments are described using a productivity or similar services herein. Embodiments are not limited to specific services or applications and may be implemented with any hosted service or application using the principles described herein.

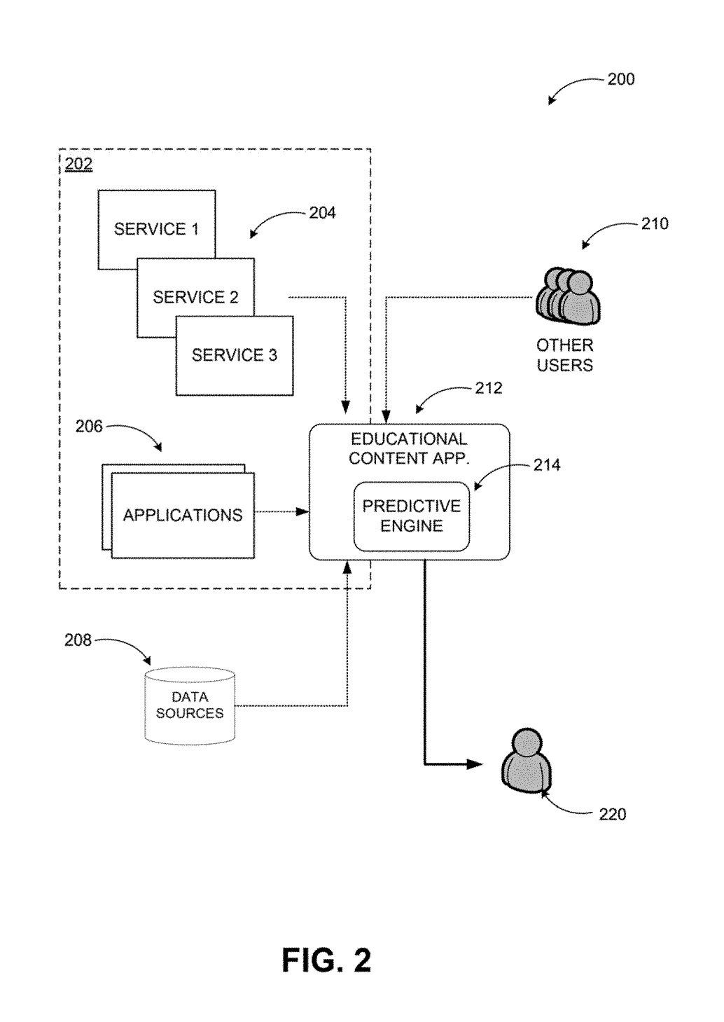

FIG. 2 is a display diagram illustrating use of a predictive engine in providing new feature discovery and presentation, according to embodiments.

As shown in a diagram 200, one or more services 204 and/or applications 206 may have features released on a regular or irregular basis. In some embodiments, an educational content application 212 may be used to present the new features to users and train them on how to use the new features. To improve a likelihood that a target user 220 will actually view the presentation and follow the training (and/or use the feature), a predictive engine 214 may be used to collect data on preference and usage of other users 210, service/application configurations (associated with the user 220 and/or other users 210), and other telemetry data. Some of the data may be collected or retrieved from external resources such as other service environments. Some of the data may be retrieved from already collected telemetry data (e.g., command level telemetry data) at data sources 208. The predictive engine 214 may then provide guidance to the educational content application 212 when and which features to present through which channels.

In some examples, features for a particular application may be presented when the user activates that particular application (e.g., opens a document in that application). Features may also be presented in a cross-application fashion. For example, the user may be editing or viewing content associated with data that can be processed by a spreadsheet application through a browser. Educational material associated with a new feature of the spreadsheet application may be displayed to the user at that point through the browser. In yet other examples, presentations may be made at operating system level, through the desktop for example.

The presented features may include existing features or new features. In some cases, existing features may he analyzed and relevant ones may be suggested to the user even if the user has not activated or used them in the past. In further embodiments, applications may not be taken into consideration alone, but an entire ecosystem of applications and/or services may be considered when selecting which features and when to present to the user.

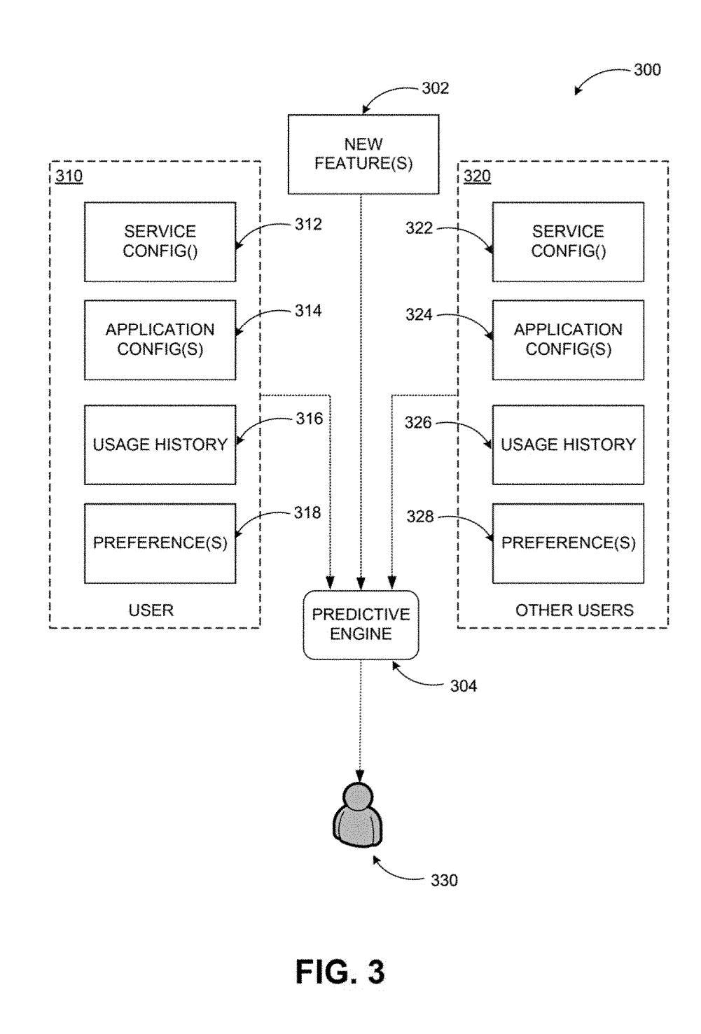

FIG. 3 is a display diagram illustrating example components in providing new feature discovery and presentation, according to embodiments.

As shown in diagram 300, predictive engine 304 may receive information associated with new available features for an application or a group of applications within an ecosystem of applications (e.g., a service or a combination of complementary services such as applications within a productivity service and a collaboration service). The predictive engine 304 may then receive one or more of service configuration(s) 312, application configuration(s) 314, usage history 316 (pattern of usage), and preferences 318 associated with the user 330. The predictive engine 304 may also receive from one or more sources service configuration(s) 322, application configuration(s) 324, usage history 326 (pattern of usage), and preferences 328 associated with the other users 320.

Information associated with other users 320 may be processed such that other users are clustered to determine groups of users whose usage and other attributes may be more relevant to the user 330. In some examples, already collected command telemetry may be used to surface commands (features) that be especially useful for a particular user. Features may also be evaluated based on usage, preferences, and configurations in other applications. For example, the usage of a particular feature in a spreadsheet application may provide insight into selection of that feature for presentation to the user for a word processing or presentation application.

In other embodiments, available features may be weighted based on the retrieved data and presented according to their weight values. For example, features heavily used by other users may be given a higher weight value compared to features less favored by others. On the other hand, weights of features may represent a combination based on the different input data. For example, the user's own usage history, preferences, etc. may be combined with other users' history and preferences to arrive at a combined weight value for the particular feature. The factors used in determining which features to present when and through which forum (channel) may also be used to determine when to stop presenting a feature.

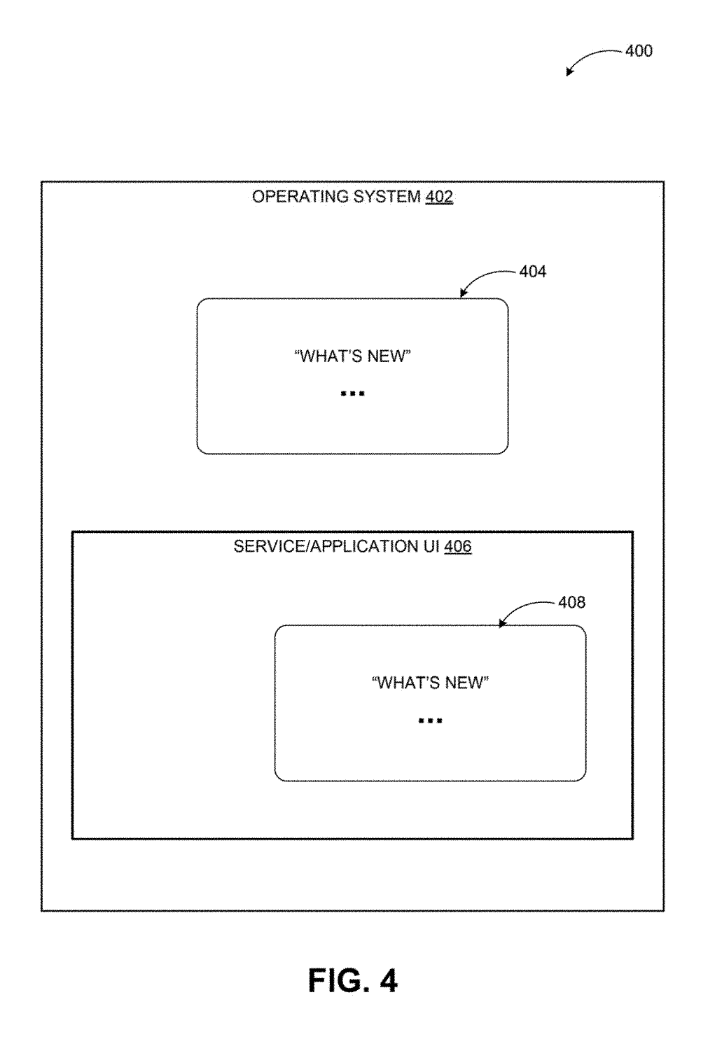

FIG. 4 is a display diagram illustrating example user interface configurations in providing new feature discovery and presentation, according to embodiments.

Diagram 400 shows different options to present educational material associated with a feature. In some embodiments, educational material (e.g., summary information, training materials) may be presented through a dialog box 404 or similar user interface via the operating system 402 of a computing device (i.e., desktop).

In other embodiments, the educational material may be presented through a dialog box or similar user interface 408 on a user interface of a particular service or application 406. The educational material may also be provided through a separate user interface, through a command bar, or any other similar surface. The feature presentation may not necessarily be through the user interface of the application to which the feature belongs. For example, presentation of a feature for a collaboration application may be displayed through the user interface of a word processing application if the system detects it may be beneficial to share the document for the user.

The example scenarios and schemas in FIG. 1 through 4 are shown with specific components, data types, and configurations. Embodiments are riot limited to systems according to these example configurations. Data driven feature identification and presentation may be implemented in confirmations employing fewer or additional components in applications and user interfaces. Furthermore, the example schema and components shown in FIG. 1 through 4 and their subcomponents may be implemented in a similar manner with other values using the principles described herein.

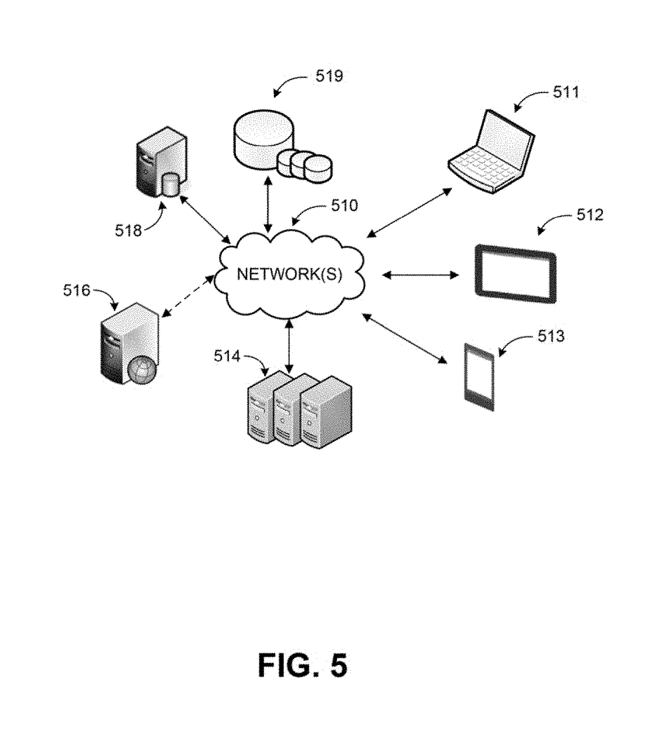

FIG. 5 is an example networked environment, where embodiments may be implemented. An application or service configured to provide data driven feature discovery and presentation may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Applications executed on any of the client devices 511-513 may facilitate communications via application(s) executed by servers 514, or on individual server 516. As discussed above, features relevant to a user may be discovered based on a number of factors and presented to the user through a variety of channels at selected times based on predictions made using those factors. The service may store data associated with the feature in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as, acoustic, RE, infrared and other wireless media.

Many other configurations of computing devices, applications, data sources, and data distribution systems may be employed to provide data driven feature discovery and presentation. Furthermore, the networked environments discussed in FIG. 5 are for illustration purposes only. Embodiments are not limited to the example applications, modules, or processes.

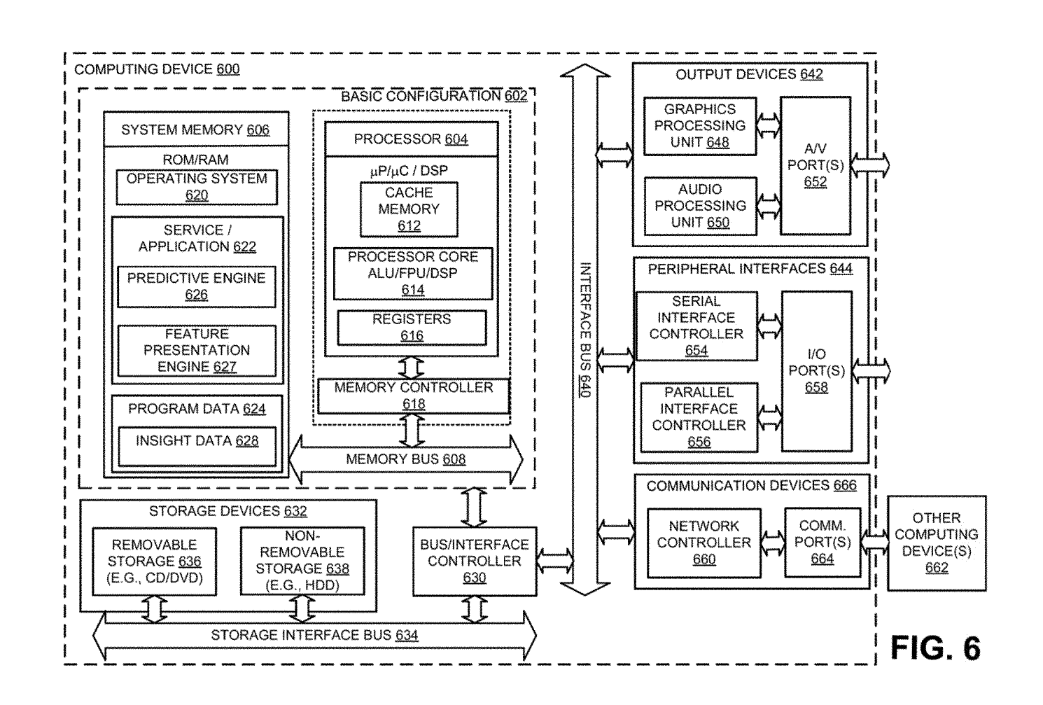

FIG. 6 is a block diagram of an example computing device, which may be used to provide data driven feature discovery and presentation, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a service/application 622, and a program data 624. The service/application 622 may include components such as a predictive engine 626 and a feature presentation engine 627. The predictive engine 626 and the feature presentation engine 627 may execute the processes associated with selecting and presenting features relevant to a user in conjunction with the service/application 622 as described herein.

The program data 624 may also include, among other data, insight data 628, or the like, as described herein. The insight data 628 may include the feature, user information such as past usage, current configuration data, other user associated data, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an, interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By was of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also he implemented as a personal computer including both laptop computer and non-laptop computer configurations.

Example embodiments may also include methods to provide a teaching UI activated by a user action. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

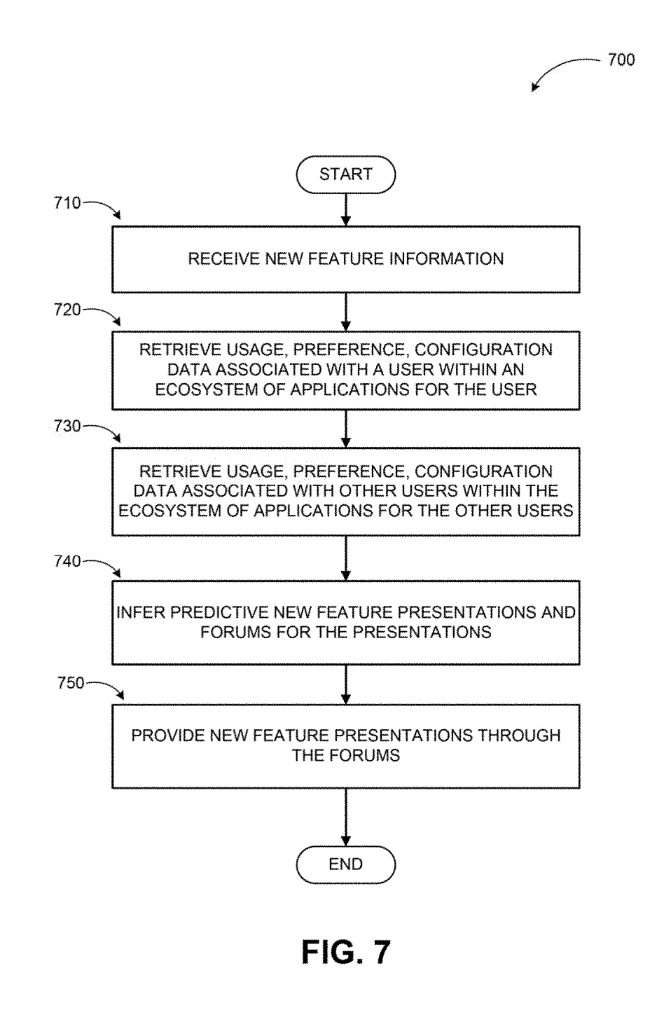

FIG. 7 is a logic flow diagram illustrating a process for providing new feature discovery and presentation, according to embodiments. Process 700 may be implemented on a computing device, such as the computing device 600 or another system.

Process 700 begins with operation 710, where a predictive engine of a service or an educational content presentation application receives new feature information. The feature may include a new or existing feature (with or without updates). At operation 720, the predictive engine may retrieve usage, preference, and configuration data associated with a user. The collected data may involve not only the application to which the feature belongs, but the ecosystem of other applications associated with the particular application.

At operation 730, the predictive engine may retrieve usage, preference, and configuration data associated with other users. The collected data may involve not only the application to which the feature belongs, but the ecosystem of other applications associated with the particular application. The other users may be selected based on a likelihood that their choices and usage may provide insight into whether or not the feature may be relevant to the user. Thus, other users may be users of similar status, background, and other attributes.

At operation 740, the predictive engine may infer which features should be presented through which forum and at which time(s). The selected feature(s) may be presented through the selected forum(s) at the determined times at operation 750.

The operations included in process 700 is for illustration purposes. Providing data driven feature selection and presentation may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device to provide data driven feature discovery and presentation is described. The computing device may include a communication interface configured to facilitate communication with other computing devices; a memory configured to store instructions associated with a hosted service; one or more processors coupled to the memory and the communication interface. The one or more processors may be executing an educational content application in conjunction with the instructions stored in the memory, where the educational content application may include a predictive engine configured to receive information associated with a feature, where the feature is associated with one or more applications within the hosted service; retrieve user information for a target user associated with the one or more applications; retrieve user information for a group of other users associated with the one or more applications; and determine whether to present the feature to the target user based on the retrieved user information for the target user and the user information for the group of other users. The educational content application may also include a feature presentation engine configured to provide educational content associated with the feature to be displayed to the target user based on the determination by the predictive engine.

According to other examples, the predictive engine may be further configured to determine a timing to present the feature to the target user and a forum to present the feature to the target user based on the retrieved user information for the target user and the user information for the group of other users; and the feature presentation engine may be further configured to provide educational content associated with the feature to be displayed to the target user at the timing and through the forum determined by the predictive engine. The forum may include one or more of a dialog display on a desktop associated with the target user, a dialog display or a command bar message on a user interface for an application associated with the feature, and a dialog display or a command bar message on a user interface for another application not associated with the feature.

According to further examples, the timing to present the feature to the target user may include one or more of when the target user signs in to the hosted service, when the target user activates the application associated with the feature, when the target user performs an action associated with the feature in another application, and when the target user turns on a computing device. The feature may be associated with two or more applications within the hosted service. The user information for the target user associated with the one or more applications may include one or more of a usage history, a hosted service configuration, an application configuration, and a preference of the target user associated with the one or more applications.

According to yet other examples, the user information for the group of other users associated with the one or more applications may include one or more of: a usage history, a hosted service configuration, an application configuration, and a preference of the group of other users associated with the one or more applications. The user information for the group of other users associated with the one or more applications may also include one or more of: a usage history, a hosted service configuration, an application configuration, and a preference of the group of other users for one or more complementary applications. The predictive engine may be further configured to select the feature to be presented to the target user from a plurality of available features based on the retrieved user information for the target user and the user information for the group of other users. The predictive engine also lie configured to select the feature to be presented to the target user from the plurality of available features based on a computing device used by the target user. The educational content may include one or more of summary information associated with the feature and training materials associated with the feature.

According to examples, a means for providing data driven feature discovery and presentation is described. The means may include a means for receiving information associated with a feature, where the feature is associated with one or more applications within a hosted service; a means for retrieving user information for a target user associated with the one or more applications; a means for retrieving user information for a group of other users associated with the one or more applications; a means for determining whether to present the feature to the target user, a timing to present the feature to the target user, and a forum to present the feature to the target user based on the retrieved user information for the target user and the user information for the group of other users; and a means for providing educational content associated with the feature to be displayed to the target user at the timing and through the forum based on the determination.

According to other examples, a method executed on a computing device to provide data driven feature discovery and presentation is described. The method may include receiving information associated with a feature, where the feature is associated with one or more applications within a hosted service; retrieving user information for a target user associated with the one or more applications; retrieving user information for a group of other users associated with the one or more applications; determining whether to present the feature to the target user, a timing, to present the feature to the target user, and a forum to present the feature to the target user based on the retrieved user information for the target user and the user information for the group of other users; and providing educational content associated with the feature to be displayed to the target user at the timing and through the forum based on the determination.

According to some examples, the method may include receiving information associated with a plurality of features; and selecting the feature to be presented to the target user from the plurality of available features based on the retrieved user information for the target user and the user information for the group of other users. The method may further include assigning a weight value to each feature in the plurality of available features based on the retrieved user information for the target user and the user information for the group of other users; and selecting the feature based on the assigned weight value.

According to other examples, the method may also include determining one or more of the timing to present the feature to the target user and the forum to present the feature to the target user based on the assigned weight value. The method may yet include determining a plurality of weight values for each feature based on individual factors within the retrieved user information for the target user and the user information for the group of other users; and determining the weight value for each feature based on one of a sum of the plurality of weight values and an average of the plurality of weight values for each feature. Determining the timing to present the feature to the target user may include determining a start time, a duration, a stop time, and a repetition frequency for a presentation of the educational content.

According to further examples, a computer-readable memory device with instructions stored thereon to provide data driven feature discovery and presentation in a productivity service environment is described. The instructions may include receiving information associated with a plurality of features, where the plurality of features is associated with one or more applications within the productivity service; retrieving user information for a target user associated with the one or more applications; retrieving user information for a group of other users associated with the one or more applications; selecting a feature to be presented to the target user front the plurality of available features based on the retrieved user information for the target user and the user information for the group of other users; determining a timing to present the feature to the target user and a forum to present the feature to the target user based on the retrieved user information for the target user and the user information for the group of other users; and providing educational content associated with the feature to be displayed to the target user at the timing and through the forum based on the determination.

According to yet further examples, the method may also include selecting the feature for one of the one or more applications based on retrieved user information for the target user and the user information for the group of other users associated with another one of the one or more applications; and providing the educational content associated with the feature to be displayed through a user interface of the other one of the one or more applications. The one or more applications may include a word processing application, a spreadsheet application, a presentation application, a graphics application, a collaboration application, a communication application, and a notetaking application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide data driven feature discovery and presentation, the computing device comprising:
a communication interface configured to facilitate communication with other computing devices;
a memory configured to store instructions associated with a hosted service;
one or more processors coupled to the it and the communication interface, the one or more processors executing an educational content application in conjunction with the instructions stored in the memory, wherein the educational content application includes
a predictive engine configured to:
receive information associated with a feature, wherein the feature is associated with one or more applications within the hosted service;
retrieve user informal for a target user associated with the one or more applications;
retrieve user information for a group of other users associated with the one or more applications; and
determine whether to present the feature to the target user based on the retrieved user information for the target user and the user information for the group of other users; and
a feature presentation engine configured to:
provide educational content associated with the feature to be displayed to the target user based on the determination by the predictive engine.

2. The computing device of claim 1, wherein
the predictive engine is further configured to:
determine a timing to present the feature to the target user and a forum to present the feature to the target user based on the retrieved user information for the target user and the user information for the group of other users; and
the feature presentation engine is further configured to:
provide educational content associated with the feature to be displayed to the target user at the timing and through the forum determined by the predictive engine.

3. The computing device of claim 2, wherein the forum includes one or more of a dialog display on a desktop associated with the target user, a dialog display or a command bar message on a user interface for an application associated with the feature, and a dialog display or a command bar message on a user interface for another application not associated with the feature.

4. The computing device of claim 2, wherein the timing to present the feature to the target user includes one or more of when the target user signs in to the hosted service, when the target user activates the application associated with the feature, when the target user performs an action associated with the feature in another application, and when the target user turns on a computing device.

5. The computing device of claim 1, wherein the feature is associated with two or more applications within the hosted service.

6. The computing device of claim 1, wherein the user information for the target user associated with the one or more applications includes one or more of: a usage history, a hosted service configuration, an application configuration, and a preference of the target user associated with the one or more applications.

7. The computing device of claim 1, wherein the user information for the group of other users associated with the one or more applications includes one or more of: a usage history, a hosted service configuration, an application configuration, and a preference of the group of other users associated with the one or more applications.

8. The computing device of claim 1, wherein the user information for the group of other users associated with the one or more applications includes one or more of: a usage history, a hosted service configuration, an application configuration, and a preference of the group of other users for one or more complementary applications.

9. The computing device of claim 1, wherein the predictive engine is further configured to:
select the feature to be presented to the target user from a plurality of available features based on the retrieved user information for the target user and the user information for the group of other users.

10. The computing device of claim 9, wherein the predictive engine is further configured to:
select the feature to be presented to the target user from the plurality of available features based on a computing device used by the target user.

11. The computing device of claim 1, wherein the educational content includes one or more of summary information associated with the feature and training materials associated with the feature.

12. A method executed on a computing device to provide data driven feature discovery and presentation, the method comprising:
receiving information associated with a feature, wherein the feature is associated with one or more applications within a hosted service;
retrieving user information for a target user associated with the one or more applications;
retrieving, user information for a group of other users associated with the one or more applications;
determining whether to present the feature to the target user, a timing to present the feature to the target user, and a forum to present the feature to the target user based on the retrieved user information for the target user and the user information for the group of other users; and
providing educational content associated with the feature to be displayed to the target user at the timing and through the forum based on the determination.

13. The method of claim 12, further comprising:
receiving information associated with a plurality of features; and
selecting the feature to be presented to the target user from the plurality of available features based on the retrieved user information for the target user and the user information for the group of other users.

14. The method of claim 13, further comprising:
assigning a weight value to each feature in the plurality of available features based on the retrieved user information for the target user and the user information for the group of other users; and
selecting the feature based on the assigned weight value.

15. The method of claim 14, further comprising:
determining one or more of the timing to present the feature to the target user and the forum to present the feature to the target user based on the assigned weight value.

16. The method of claim 14, further comprising:
determining a plurality of weight values for each feature based on individual factors within the retrieved user information for the target user and the user information for the group of other users; and
determining the weight value for each feature based on one of a sum of the plurality of weight values and an average of the plurality of weight values for each feature.

17. The method of claim 12, wherein determining the timing to present the feature to the target user comprises:
determining a start time, a duration, a stop time, and a repetition frequency for presentation of the educational content.

18. A computer-readable memory device with instructions stored thereon to provide data driven feature discovery and presentation in a productivity service environment, the instructions comprising:
receiving information associated with a plurality of features, wherein the plurality of features is associated with one or more applications within the productivity service;
retrieving user information for a target user associated with the one or more applications;
retrieving user information for a group of other users associated with the one or more applications;
selecting a feature to be presented to the target user from the plurality of available features based on the retrieved user information for the target user and the user information for the group of other users;
determining a timing to present the feature to the target user and a forum to present the feature to the target user based on the retrieved user information for the target user and the user information for the group of other users; and
providing educational content associated with the feature to be displayed to the target user at the timing and through the forum based on the determination.

19. The computer-readable memory device of claim 18, wherein the instructions further compose:
selecting the feature for one of the one or more applications based on retrieved user information for the target user and the user information for the group of other users associated with another one of the one or more applications; and
providing the educational content associated with the feature to be displayed through a user interface of the other one of the one or more applications.

20. The computer-readable memory device of claim 18, wherein the one or more applications include a word processing application, a spreadsheet application, a presentation application, a graphics application, a collaboration application, a communication application, and a notetaking application.
